(19) United States
(12) Patent Application Publication
(10) Pub. No.: US 2018/0313334 A1
(43) Pub. Date: Nov. 1, 2018

(54) HOISTABLE PLATFORM ASSEMBLY WITHIN A NACELLE OF A WIND TURBINE

(71) Applicant: General Electric Company, Schenectady, NY (US)

(72) Inventors: Brian William Manikas, Schenectady, NY (US); Brian Thomas Misavage, Ballston Spa, NY (US); Michael Frederick Sander, Colonie, NY (US); Gregory Clarence Thomas, Saratoga Springs, NY (US); Kevin Tyler Eherts, Albany, NY (US); Hunter Ryan Anderson, Muskegon, MI (US); Darrick Adam Vanderwalker, Pattersonville, NY (US); Waylon James Esser, Canova, SD (US)

(21) Appl. No.: 15/498,704

(22) Filed: Apr. 27, 2017

(51) Int. Cl. F03D 13/40; F03D 13/20; F03D 13/10

(52) U.S. Cl. CPC F03D 13/40; F05B 2230/80; F03D 13/10; F03D 13/22

(57) ABSTRACT

The present disclosure is directed to a hoistable platform assembly used in uptower wind turbine repairs. The platform assembly includes at least one working platform having a working surface and a platform frame. The platform frame is configured for securement within a nacelle of the wind turbine. The platform assembly also includes a plurality of tooling containers secured to the working surface. Each of the tooling containers includes at least one tool secured therein that is required for the uptower wind turbine repairs. Further, the platform assembly includes a frame structure arranged above the plurality of tooling containers and secured to the working surface via one or more connecting members.

### FIELD OF THE INVENTION

The present subject matter relates generally to wind turbines, and more particularly to hoistable working platforms that can be easily lifted uptower with desired repair tools mounted thereon and that subsequently provide working surfaces within a nacelle of a wind turbine during repair procedures.

### BACKGROUND OF THE INVENTION

Wind power is considered one of the cleanest, most environmentally friendly energy sources presently available, and wind turbines have gained increased attention in this regard. A modern wind turbine typically includes a tower, a generator, a gearbox, a nacelle, and one or more rotor blades. The nacelle includes a rotor assembly coupled to the gearbox and to the generator. The rotor assembly and the gearbox are mounted on a bedplate member support frame located within the nacelle. More specifically, in many wind turbines, the gearbox is mounted to the bedplate member via one or more torque supports or arms. The one or more rotor blades capture kinetic energy of wind using known airfoil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

More specifically, the majority of commercially available wind turbines utilize multi-stage geared drivetrains to connect the turbine blades to electrical generators. The wind turns the rotor blades, which spin a low speed shaft, i.e. the main shaft. The main shaft is coupled to an input shaft of the gearbox, which has a higher speed output shaft connected to the generator. Thus, the geared drivetrain aims to increase the velocity of the mechanical motion. Further, the main shaft is typically externally supported by one or more bearings. In addition, the gearbox and the generator are mounted to the bedplate member via one or more torque arms or supports.

Over time, the main shaft and associated bearings may become worn and/or damaged due to loads and forces from the wind acting on the wind turbine components. Unfortunately, repair of main shaft and the main bearing(s) often requires the turbine machine head to be removed from atop the nacelle and transported to a factory, which can be very time-consuming and expensive. Even still, if such repairs are made uptower, a variety of tools must be lifted to the nacelle with a crane. Currently, such tools are lifted uptower individually, which is expensive and time consuming. Further, once the tools are inside of the nacelle, personnel have minimal space and/or working surfaces to make the needed repairs.

Thus, the present disclosure is directed to a hoistable working platform that addresses the aforementioned issues. More specifically, the present disclosure is directed to hoistable working platforms that can be easily lifted uptower with desired repair tools mounted thereon and that subsequently provide working surfaces within a nacelle of a wind turbine during repair procedures.

### BRIEF DESCRIPTION OF THE INVENTION

Aspects and advantages of the invention will be set forth in part in the following description, or may be obvious from the description, or may be learned through practice of the invention.

In one aspect, the present disclosure is directed to a hoistable platform assembly used in uptower wind turbine repairs. The platform assembly includes at least one working platform having a working surface and a platform frame. The platform frame is configured for securement within a nacelle of the wind turbine. The platform assembly also includes a plurality of tooling containers secured to the working surface. Each of the tooling containers includes at least one tool secured therein that is required for the uptower wind turbine repairs. Further, the platform assembly includes a frame structure arranged above the plurality of tooling containers and secured to the working surface via one or more connecting members, e.g. cables, columns, or similar.

In one embodiment, the frame structure may further include a first set of lifting devices and a second set of lifting devices. In addition, the working surface may include a corresponding set of lifting devices that align with the first set of lifting devices of the frame structure. As such, the securement cable(s) can be secured to each of the lifting devices.

In another embodiment, the frame structure may include parallel columns having a plurality of beams mounted perpendicularly thereto. In such embodiments, the platform assembly may include an even number of the second set of lifting devices such that the same number of lifting devices can be mounted to each of the parallel columns.

In further embodiments, the platform assembly may include a hoisting cable configured with each of the first set of lifting devices. Further, the hoistable cables may be joined together at a node, which provides an attachment location for a crane capable of lifting the platform assembly uptower. In certain embodiments, the lifting devices may correspond to hoist rings.

In particular embodiments, the platform frame is configured to sit within an opening within the nacelle where one or more drivetrain components (e.g. such as a main shaft, a main bearing, a gearbox, a generator shaft, a generator, or similar) has been removed. More specifically, in certain embodiments, the platform frame may include one or more locking features configured to secure the working platform within the opening. In addition, the platform assembly may include an additional platform secured to the platform frame of the working platform e.g. that can be used uptower during the wind turbine repairs.

In additional embodiments, the working platform may be constructed of any suitable material configured to support a desired weight, such as at least five hundred (500) pounds per square feet (lbs/ft²). For example, in certain embodiments, the material may include aluminum, wood, steel, a composite material, or combinations thereof.

In another aspect, the present disclosure is directed to a disassembled wind turbine under repair. The wind turbine includes a tower secured to a foundation, a nacelle mounted atop the tower, a bedplate arranged within the nacelle, and a hoistable platform assembly. The nacelle includes a base wall, side walls, a front wall, a rear wall, and a top lid. Further, the base wall includes at least one opening. The bedplate includes one or more areas configured to receive at least one drivetrain component. Thus, the hoistable platform assembly is secured within the nacelle in at least one of the opening or the one or more areas. Moreover, the hoistable platform assembly includes a working surface, a platform frame, and a plurality of tooling containers secured to the working surface. Each of the tooling containers includes at least one tool secured therein that is required for the uptower wind turbine repairs. It should be understood that the wind turbine may further include any of the additional features as described herein.

In yet another aspect, the present disclosure is directed to a method for preparing a wind turbine for an uptower repair procedure. The method includes removing at least one drivetrain component supported by a bedplate of the wind turbine from within of a nacelle of the wind turbine. Further, the method includes lifting a platform assembly uptower. As mentioned, the platform assembly has a working surface, a platform frame, and a plurality of tooling containers secured to the working surface, with each of the tooling containers having at least one tool secured therein that is required for the uptower repair procedure. The method also includes installing the platform frame of the platform assembly within the nacelle at a location of the removed drivetrain component.

In one embodiment, the step of installing the platform frame of the platform assembly within the nacelle at the location of the removed drivetrain component includes fitting the platform frame into the location via one or more locking features thereof. In another embodiment, the step of removing at least one drivetrain component supported by the bedplate of the wind turbine from within of the nacelle of the wind turbine reveals an opening in a base wall of the nacelle. As such, the method may also include covering the opening in the base wall of the nacelle with the platform assembly.

It should also be understood that the method may further include any of the additional step and/or features as described herein.

These and other features, aspects and advantages of the present invention will be further supported and described with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine according to the present disclosure;

FIG. 2 illustrates a simplified, internal view of one embodiment of a nacelle of a wind turbine according to the present disclosure, particularly illustrating the nacelle during normal operation;

FIG. 3 illustrates a perspective view of one embodiment of a housing assembly of a wind turbine including the nacelle and a bedplate thereof according to the present disclosure;

FIG. 4 illustrates a simplified, internal view of one embodiment of a nacelle of a wind turbine according to the present disclosure, particularly illustrating the nacelle during a repair procedure where the generator has been removed;

FIG. 5 illustrates a simplified, internal view of one embodiment of a nacelle of a wind turbine according to the present disclosure, particularly illustrating the nacelle during a repair procedure where the generator and the gearbox have been removed;

FIG. 6 illustrates a perspective view of one embodiment of a platform assembly according to the present disclosure;

FIG. 7 illustrates a side view of one embodiment of a platform assembly according to the present disclosure;

FIG. 8 illustrates a front view of one embodiment of a platform assembly according to the present disclosure;

FIG. 9 illustrates a detailed view of a portion of a bedplate of a nacelle of a wind turbine according to the present disclosure, particularly illustrating multiple working platforms covering a hole left by removal of a gearbox of the wind turbine;

FIG. 10 illustrates a perspective view of one embodiment of a working platform according to the present disclosure, particularly illustrating a working surface of the working platform mounted atop a platform frame thereof;

FIG. 11 illustrates a perspective view of the working platform of FIG. 10 with the working surface thereof removed to further illustrate details of the platform frame;

FIG. 12 illustrates a perspective view of another embodiment of a working platform according to the present disclosure, particularly illustrated a safety door the platform in a closed position;

FIG. 13 illustrates a perspective view of another embodiment of a working platform according to the present disclosure, particularly illustrated a safety door the platform in an open position;

FIG. 14 illustrates a top view of one embodiment of a working platform according to the present disclosure; and

FIG. 15 illustrates a flow diagram of one embodiment of a method for preparing a wind turbine for an uptower repair procedure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

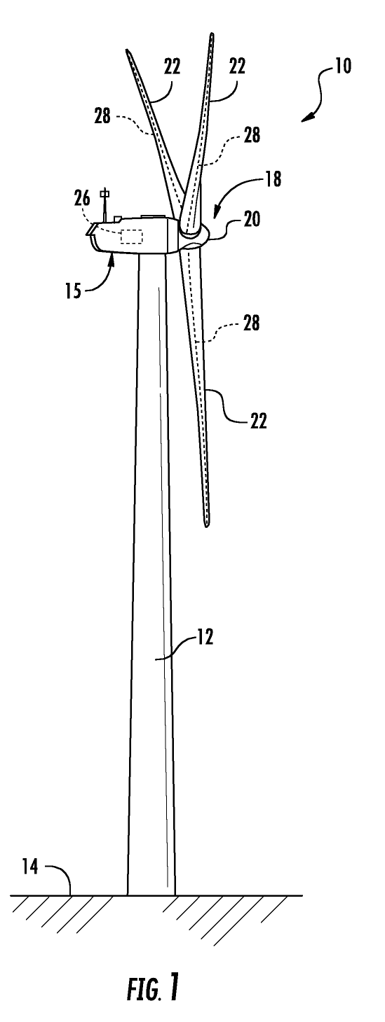

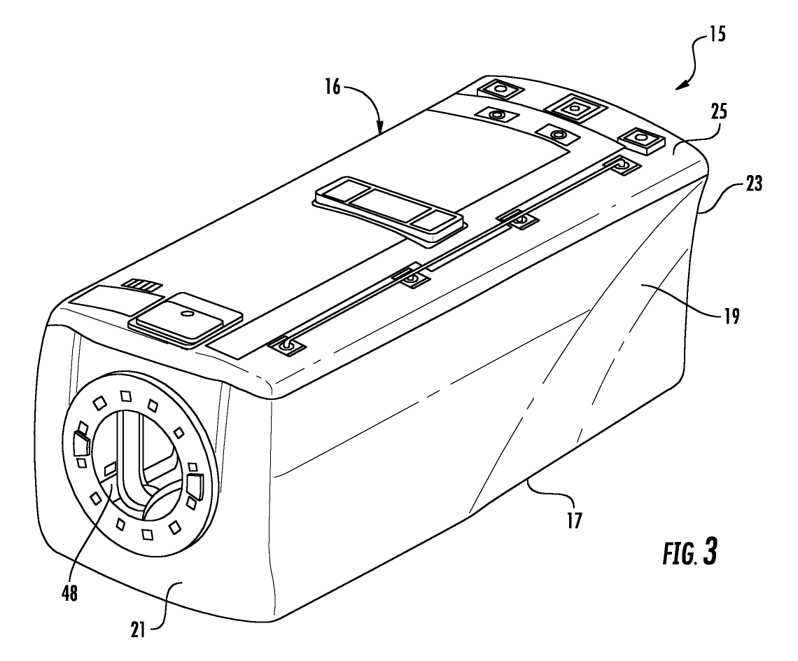

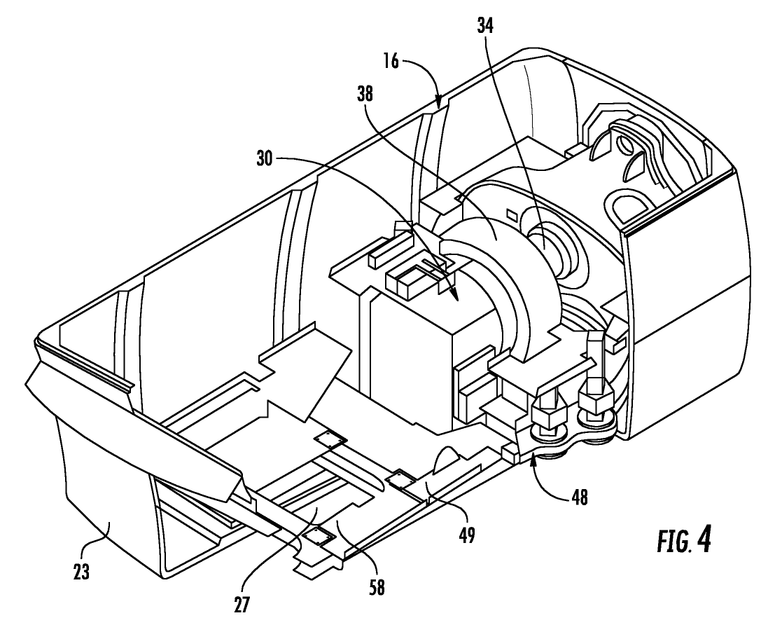

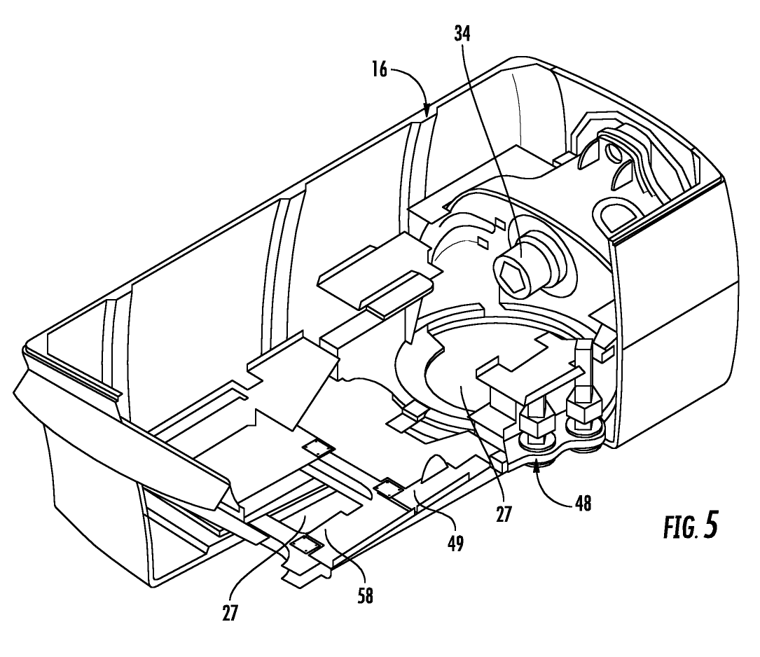

Referring now to the drawings, FIG. 1 illustrates a perspective view of one embodiment of a wind turbine 10 according to the present disclosure. As shown, the wind turbine 10 generally includes a tower 12 extending from a support surface 14, a housing assembly 15 mounted on the tower 12, and a rotor 18 coupled to the housing assembly 15. More specifically, as shown particularly in FIG. 3, the housing assembly 15 may include a nacelle 16 and a bedplate 48 arranged within the nacelle 16. As such, the nacelle 16 corresponds to the overall housing structure and has a base wall 17, opposing side walls 19, a front wall 21, a rear wall 23, and a top lid 25. Further, as shown in FIGS. 4 and 5, the base wall 17 may include one or more openings 27. For example, one of the openings 27 may be provided for coupling the nacelle 16 with the tower 12. More specifically, as shown, a yaw bearing 54 may be positioned in the opening 27 of the base wall 17 or adjacent thereto, with is coupled to the tower 12 and allows for rotation of the nacelle 16 with respect to the wind, which is discussed in more detail below. Alternatively, the openings 27 may be at any other location in the base wall 17, e.g. to accommodate the various drivetrain components configured therein.

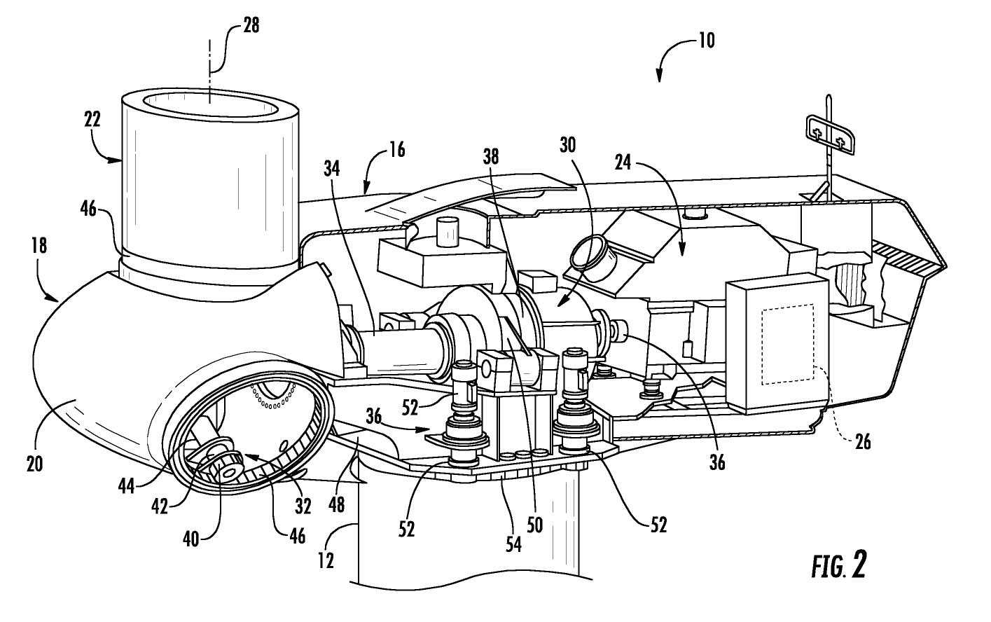

Referring back to FIG. 1, the rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator 24 (FIG. 2) positioned within the nacelle 16 to permit electrical energy to be produced. In particular embodiments, as shown in FIGS. 4 and 5, a generator frame 49 may also be secured to the bedplate 48 (e.g. via a bolted connection) for supporting the generator 24.

The wind turbine 10 may also include a wind turbine controller 26 centralized within the nacelle 16. However, in other embodiments, the controller 26 may be located within any other component of the wind turbine 10 or at a location outside the wind turbine 10. Further, the controller 26 may be communicatively coupled to any number of the components of the wind turbine 10 in order to control the components. As such, the controller 26 may include a computer or other suitable processing unit. Thus, in several embodiments, the controller 26 may include suitable computer-readable instructions that, when implemented, configure the controller 26 to perform various different functions, such as receiving, transmitting and/or executing wind turbine control signals.

Referring now to FIG. 2, a simplified, internal view of one embodiment of the nacelle 16 of the wind turbine 10 shown in FIG. 1, particularly illustrating the drivetrain components thereof, is illustrated. The drivetrain components described herein may include any one of or combination of a main shaft, a main bearing, a gearbox, a generator shaft, a generator, or similar. Further, as shown, the generator 24 may be coupled to the rotor 18 for producing electrical power from the rotational energy generated by the rotor 18. The rotor 18 may include a main shaft 34 rotatable via a main bearing (not shown) coupled to the hub 20 for rotation therewith. The main shaft 34 may, in turn, be rotatably coupled to a gearbox output shaft 36 of the generator 24 through a gearbox 30. The gearbox 30 may include a gearbox housing 38 that is connected to the bedplate 48 by one or more torque arms 50. In other words, the bedplate 48 may be a forged component in which the main bearing (not shown) is seated and through which the main shaft 34 extends. As is generally understood, the main shaft 34 provides a low speed, high torque input to the gearbox 30 in response to rotation of the rotor blades 22 and the hub 20. Thus, the gearbox 30 thus converts the low speed, high torque input to a high speed, low torque output to drive the gearbox output shaft 36 and, thus, the generator 24.

Each rotor blade 22 may also include a pitch adjustment mechanism 32 configured to rotate each rotor blade 22 about its pitch axis 28. Further, each pitch adjustment mechanism 32 may include a pitch drive motor 40 (e.g., any suitable electric, hydraulic, or pneumatic motor), a pitch drive gearbox 42, and a pitch drive pinion 44. In such embodiments, the pitch drive motor 40 may be coupled to the pitch drive gearbox 42 so that the pitch drive motor 40 imparts mechanical force to the pitch drive gearbox 42. Similarly, the pitch drive gearbox 42 may be coupled to the pitch drive pinion 44 for rotation therewith. The pitch drive pinion 44 may, in turn, be in rotational engagement with a pitch bearing 46 coupled between the hub 20 and a corresponding rotor blade 22 such that rotation of the pitch drive pinion 44 causes rotation of the pitch bearing 46. Thus, in such embodiments, rotation of the pitch drive motor 40 drives the pitch drive gearbox 42 and the pitch drive pinion 44, thereby rotating the pitch bearing 46 and the rotor blade 22 about the pitch axis 28. Similarly, the wind turbine 10 may include one or more yaw drive mechanisms 52 communicatively coupled to the controller 26, with each yaw drive mechanism(s) 52 being configured to change the angle of the nacelle 16 relative to the wind (e.g., by engaging a yaw bearing 54 of the wind turbine 10).

During operation of the wind turbine 10, the various drivetrain components may become worn and/or damaged due to loads and forces from the wind acting on the wind turbine components. As such, the damaged drivetrain components are typically removed from or relocated in the nacelle 16. For example, as shown in FIG. 4, a partial internal view of one embodiment of the nacelle 16 is illustrated with the generator 24 removed. In addition, as shown in FIG. 5, a partial internal view of another embodiment of the nacelle 16 is illustrated with the generator 24 and the gearbox 30 removed. Thus, as shown in FIGS. 4 and 5, removal of such drivetrain components can create hazardous openings where the components were once located. More specifically, as shown in FIG. 4, by removing the generator 24, one of the openings 27 in the base wall 17 of the nacelle 16 is exposed, thereby creating a potentially hazardous fall hazard for personnel. In addition, the bedplate frame 48 is typically shaped and designed for the drivetrain components and does not provide a safe and even working surface.

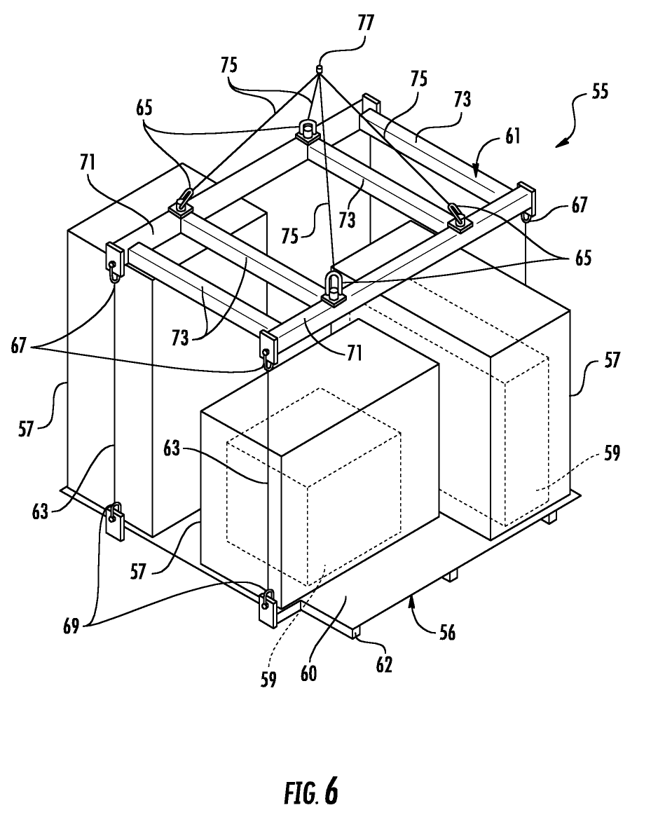

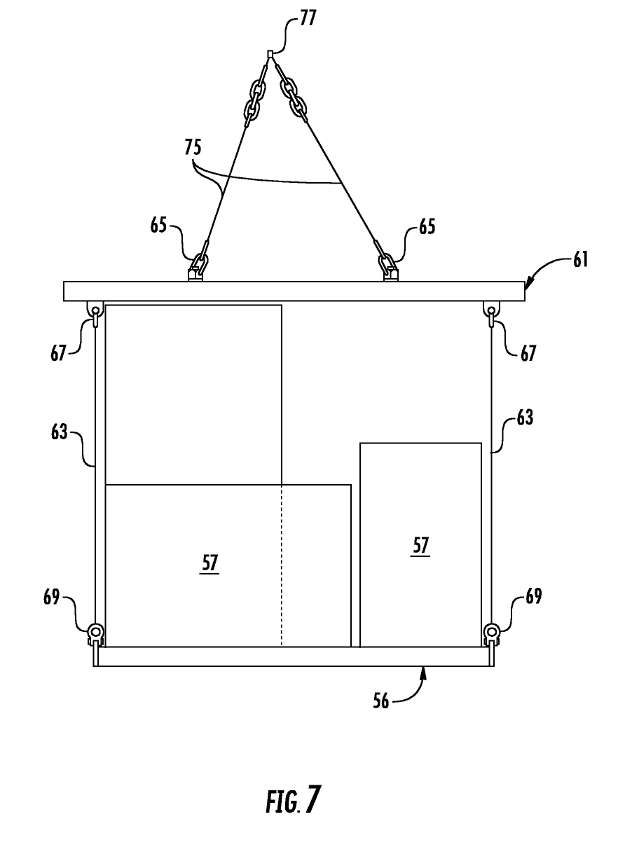

As such, the present disclosure is directed to a hoistable platform assembly 55 that can be used in uptower wind turbine repairs. More specifically, as shown in FIGS. 6-8, the platform assembly 55 includes at least one working platform 56 having a working surface 60 and a platform frame 62. As such, the platform frame 62 is configured for securement within the nacelle 16 of the wind turbine 10. More specifically, the platform frame 62 of the working platform 56 may be installed within the nacelle 16 in the locations where the drivetrain components have been moved or removed so as to provide safe working spaces therein. Further, as shown, the platform assembly 55 also includes a plurality of tooling containers 57 secured to the working surface 60. Moreover, as shown in FIG. 6, each of the tooling containers 57 includes at least one tool 59 secured therein that is required for the uptower wind turbine repairs. It should be understood that the tools 59 described herein may include any suitable tools that may be needed to complete the uptower wind turbine repairs such as, but not limited to, screwdrivers, wrenches, sockets, hammers, cleaning supplies (such as rags, trash bags, plastic wrap, putty scrapers, WD-40, Simple Green, rigging, measuring equipment, specialized tooling equipment, tie off equipment for personnel safety, power tools, hydraulic cylinders and pumps, tool manuals, heaters, etc.

In addition, as shown, the platform assembly 55 includes a frame structure 61 arranged above the plurality of tooling containers 57 and secured to the working surface 60 via one or more connecting members 63. For example, as shown, the connecting members 63 correspond to cables. In further embodiments, the connecting members 63 may correspond to rigid vertical beams or columns either permanently or removably affixed to the frame structure 61 and the working surface 60.

In addition, as shown in the illustrated embodiment, the frame structure 61 may include parallel columns 71 having a plurality of beams 73 mounted perpendicularly thereto. In another embodiment, the columns 71 may not be parallel, but rather, may be arranged in a triangular pattern. In alternative embodiments, the frame structure 61 may have an X-configuration. It should be understood that such configurations are provide for illustrative purposes only and are not meant to be limiting. As such, any configuration of the columns 71 and/or the beams 73 are within the scope and spirit of the invention.

In addition, as shown, the frame structure 61 may further include a first set of lifting devices 65 and a second set of lifting devices 67. For example, as shown, the first set of lifting devices 65 are mounted to an upward side of the parallel columns 71, whereas the second set of lifting devices 67 are mounted to ends of the parallel columns 71 such that the second set of lifting devices 67 point downward. Thus, as shown, the working surface 60 of the platform 56 may also include a corresponding set of lifting devices 69 that align with the second set of lifting devices 67 of the frame structure 61. As such, the securement cable(s) 63 can be secured between the aligned lifting devices 65, 69. More specifically, as shown, the platform assembly 55 may include an even number of the second set of lifting devices 67 such that the same number of lifting devices can be mounted to each of the parallel columns 71. For example, as shown, two lifting devices 67 are mounted to each column 71.

It should be understood that any number of lifting devices can be utilized with the platform assembly 55 so as to support any suitable weight thereof as well as to provide a balanced center of gravity during lifting the assembly 55 uptower. In addition, the lifting devices described herein may include any suitable attachment location, such as but not limited to hoist rings or D-rings.

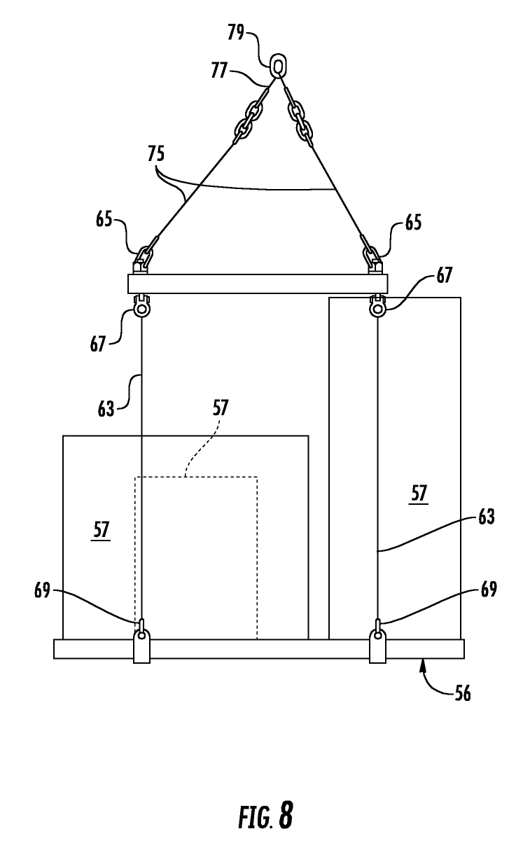

In further embodiments, the platform assembly 55 may include a hoisting cable 75 configured with each of the first set of lifting devices 65. Further, as shown in FIGS. 6-8, the hoistable cables 75 may be joined together at a node 77, which provides an attachment location 79 for a crane capable of lifting the platform assembly uptower. For example, as shown particularly in FIG. 8, the attachment location 79 includes an attachment ring for attaching a crane thereto.

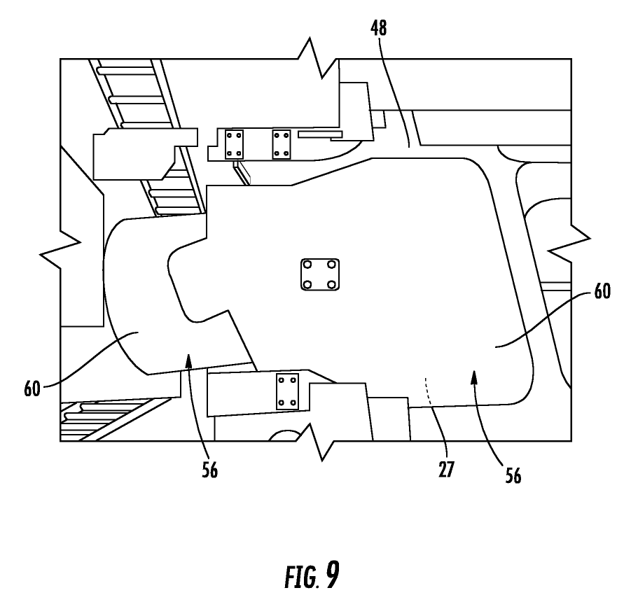

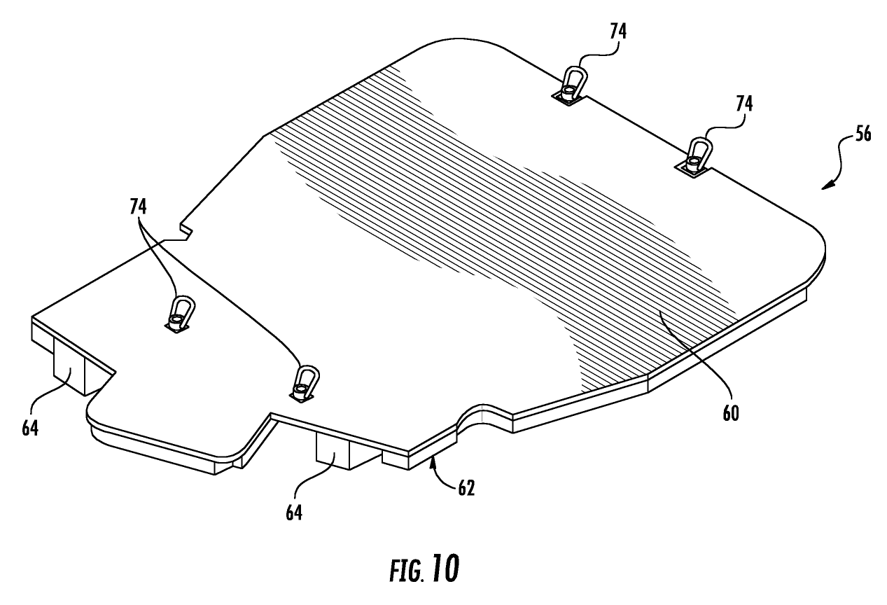

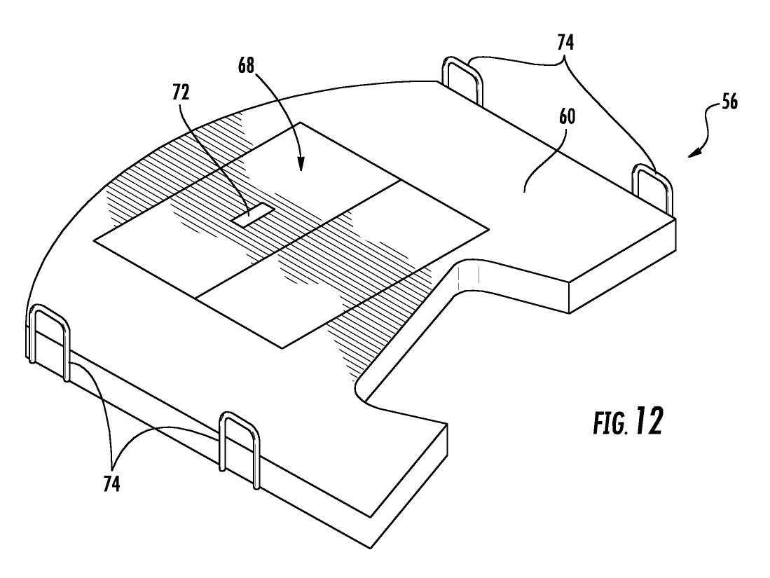

Referring now to in FIGS. 9-14, various views of the working platform 56 of the platform assembly 55 according to the present disclosure are illustrated. It should be understood that any number of working platforms 56 may be utilized to create a safe working space. For example, as shown in FIG. 9, the opening 27 has been covered with multiple working platforms 56 according to the present disclosure. More specifically, as shown, two working platforms 56 having the shapes illustrated in FIGS. 10 and 12 have been arranged together to cover the opening 27. Thus, as shown, at least two platforms may be secured within the opening 27 of the base wall 17 (i.e. where the gearbox 30 used to sit) and an additional platform may be secured within one of the openings 27 where the generator 24 used to sit (i.e. near area 58 of FIG. 4).

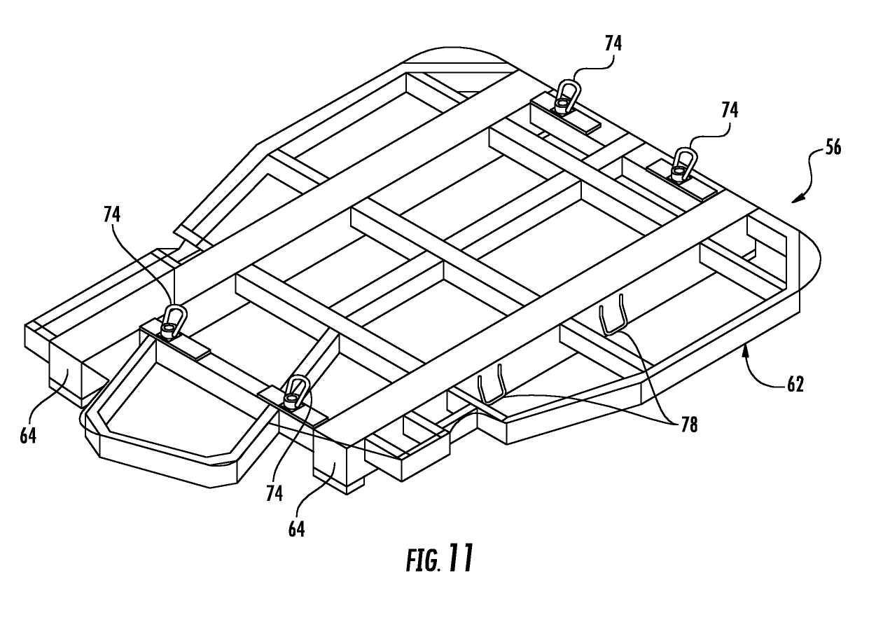

Further, the working platform(s) 56 may include a working surface 60 mounted atop an optional platform frame 62. Thus, as shown particularly in FIG. 11, the platform frame 62 may include any suitable beam structure having any number of columns, and beams, girders, spandrels, and trusses connected to one another and to the columns, so as to provide the desired strength to the working surface 60. In addition, as shown in the embodiment illustrated in FIG. 9, the platform frame 62 may be configured to sit within one of the openings (i.e. opening 27) of the bedplate 48 where the drivetrain component (i.e. the gearbox 30) has been removed, thereby creating a safe and sturdy work area for personnel. In certain embodiments, the working surface 60 of the platform assembly 55 may sit flush with the bedplate 48.

In another embodiment, as shown in FIGS. 10 and 11, the platform frame 62 may also include one or more locking features 64 configured to secure the working platform 56 within at least one of the openings 27. For example, as shown, the locking features 64 may correspond to feet that sit within and lock to the bedplate 48, e.g. via an interference fit and/or by securing the locking features 64 via one or more fasteners.

In addition, the platform assembly 55 may include an additional platform secured to the platform frame 62 of the working platform 56 e.g. that can be used uptower during the wind turbine repairs. For example, as shown in FIG. 11, the platform frame 62 may include one or more mounting locations 78 such that additional platforms can be secured to the platform frame 62 and lifted uptower simultaneously with the platform assembly 55.

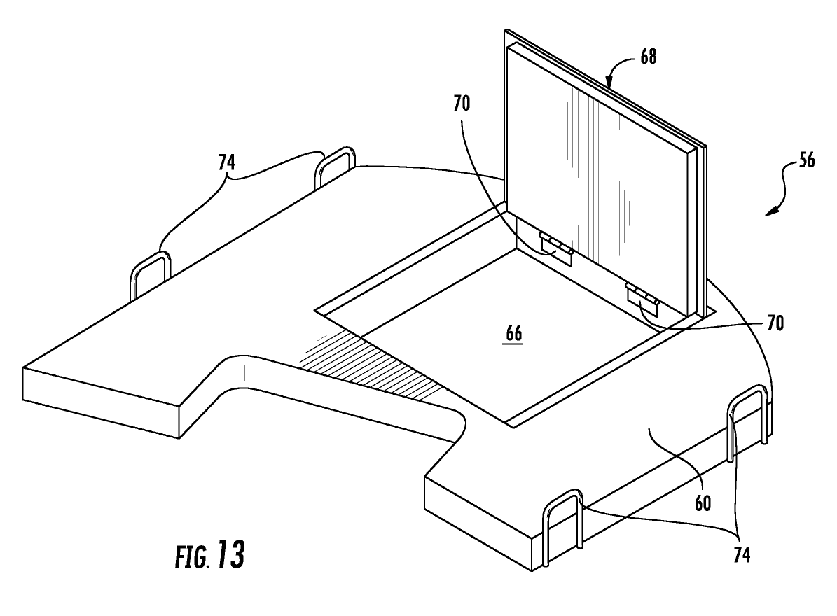

Referring now to FIGS. 12 and 13, the working platform(s) 56 may also include a manhole 66 covered by a safety door 68 movably coupled to the working platform 56, e.g. via one or more hinges 70. Thus, as shown, the safety door 68 can be moved between a closed position (FIG. 12) and an open position (FIG. 13) to allow personnel to pass therethrough. In addition, the manhole 66 provides an aperture for a ladder, such as an escape ladder (not shown), to fit therethrough. Moreover, as shown in FIG. 12, the safety door 68 may also include a handle 72 for easily changing the position of the door 68. In additional embodiments, the working platform(s) 56 may further include any additional features configured to receive various emergency escape devices. For example, the additional features may include a hole, slit, slot, recess, or anchor location, whereas the emergency escape devices may include a ladder, one or more cables, a harness, first aid equipment, and/or any other emergency personnel escape devices.

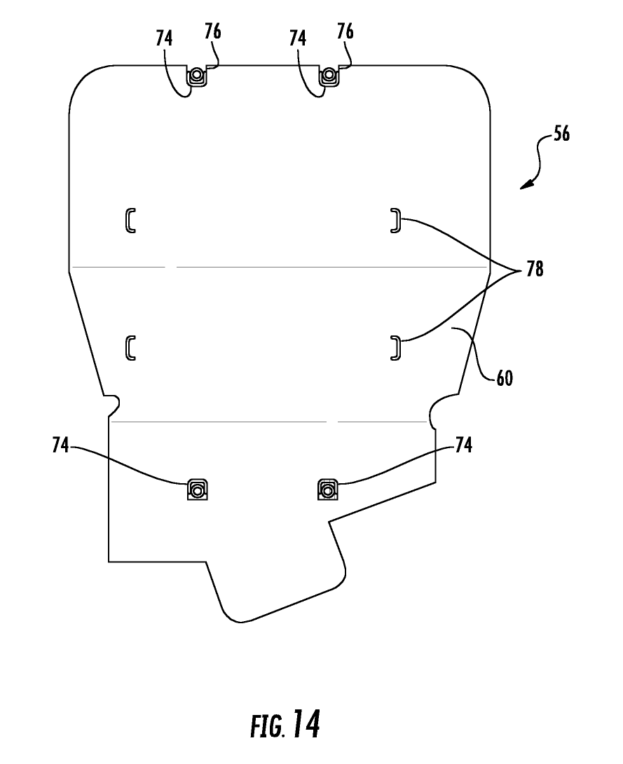

In additional embodiments, as shown in FIGS. 10-14, the working platform(s) 56 may include one or more lifting devices 74. For example, as shown in FIGS. 10, 11, and 14, the lifting devices 74 correspond to hoist rings. Alternatively, as shown in FIGS. 12 and 13, the lifting devices 74 may correspond to D-rings. As such, one or more cables may be secured to the lifting devices 74 for easily lifting and lowering the working platform(s) 56 uptower. Further, the lifting devices 74 may be mounted (e.g. via welding or bonding) to the working surface 60 of the platform 56 or the platform frame 62. In addition, as shown particularly in FIG. 14, one or more of the lifting devices 74 may be secured to the edge of the working platform 56, e.g. within a groove 76 or notch formed therein. Alternatively, the lifting device(s) 74 may be clamped to the edges of the working platform 56.

In further embodiments, the working platform 56 of the present disclosure may also be configured with additional features such as hole(s), slot(s), or similar e.g. in the working surface 60 and/or the platform frame 62 to allow one or more cables to pass therethrough. As such, the cables may be used for easily lifting and lowering the working platform(s) 56 uptower.

It should also be understood that the working platform(s) 56 described herein may be constructed of any suitable material and may have any desired shape. For example, in certain embodiments, the working platform(s) 56 may be constructed of a material configured to support any suitable weight. More specifically in one embodiment, the working platform 56 may support a weight of at least 500 lbs/ft². Such materials may include but are not limited to aluminum, wood, steel, a composite material, or combinations thereof. Alternatively, the working platform 56 may support a weight of less than 500 lbs/ft². Further, as shown, the shape of the working platforms 56 may be desired to generally correspond to the shape of the hole or opening that the platform 56 is covering.

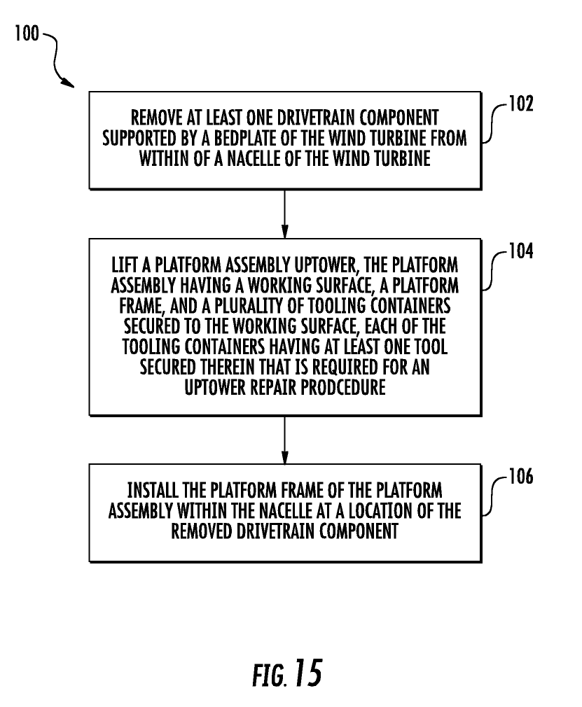

Referring now to FIG. 15, a flow diagram of one embodiment of a method 100 for preparing a wind turbine, such as the wind turbine 10 of FIG. 1, for an uptower repair procedure is illustrated. As shown at 102, the method 100 includes removing at least one drivetrain component supported by the bedplate 48 of the wind turbine 10 from within of the nacelle 16 of the wind turbine 10. In one embodiment, the step of removing at least one drivetrain component supported by the bedplate 48 of the wind turbine 10 from within of the nacelle 16 may reveal an opening 27, e.g. in the base wall 17 of the nacelle 16. As such, the method 100 may further include covering the opening 27 in the base wall 17 of the nacelle 16 with the platform assembly 55. As shown at 104, the method 100 includes lifting the platform assembly 55 of the present disclosure uptower. As shown at 106, the method 100 includes installing the platform frame 62 of the platform assembly 55 within the nacelle 16 at a location of the removed drivetrain component. More specifically, in one embodiment, the step of installing the working platform(s) 56 within the nacelle 16 at the location of the removed drivetrain component may include fitting the platform frame 62 into the location via one or more locking features 64 thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A hoistable platform assembly used in uptower wind turbine repairs, the platform assembly comprising:
at least one working platform comprising a working surface and a platform frame, the platform frame configured for securement within a nacelle of the wind turbine;
a plurality of tooling containers secured to the working surface, each of the tooling containers comprising at least one tool secured therein that is required for the uptower wind turbine repairs; and,
a frame structure arranged above the plurality of tooling containers and secured to the working surface via one or more connecting members.

2. The platform assembly of claim 1, wherein the frame structure comprises a first set of lifting devices and a second set of lifting devices.

3. The platform assembly of claim 2, wherein the working surface comprises a corresponding set of lifting devices that align with the first set of lifting devices of the frame structure, the one or more connecting members being secured to each of the lifting devices.

4. The platform assembly of claim 2, wherein the frame structure further comprises parallel columns having a plurality of beams mounted perpendicularly thereto.

5. The platform assembly of claim 4, further comprising an even number of the second set of lifting devices, wherein the same number of lifting devices is mounted to each of the parallel columns.

6. The platform assembly of claim 5, further comprising a hoisting cable configured with each of the first set of lifting devices, the hoistable cables joined together at a node, the node comprising an attachment location for a crane capable of lifting the platform assembly uptower.

7. The platform assembly of claim 3, wherein the lifting devices comprise hoist rings.

8. The platform assembly of claim 1, wherein the platform frame is configured to sit within an opening within the nacelle where one or more drivetrain components has been removed.

9. The platform assembly of claim 8, wherein the platform frame comprises one or more locking features configured to secure the working platform within the opening.

10. The platform assembly of claim 1, further comprising an additional platform secured to the platform frame of the working platform.

11. The platform assembly of claim 1, wherein the working platform is constructed of a material configured to support a weight of at least five hundred (500) pounds per square feet (lbs/ft²), wherein the material comprises at least one of aluminum, wood, steel, a composite material, or combinations thereof.

12. A disassembled wind turbine under repair, comprising:
a tower secured to a foundation;
a nacelle mounted atop the tower, the nacelle comprising a base wall, side walls, a front wall, a rear wall, and a top lid, the base wall comprising at least one opening;
a bedplate arranged within the nacelle, the bedplate comprising one or more areas configured to receive at least one drivetrain component; and,
a hoistable platform assembly secured within the nacelle in at least one of the opening or the one or more areas, the hoistable platform assembly comprising a working surface, a platform frame, and a plurality of tooling containers secured to the working surface, each of the tooling containers comprising at least one tool secured therein that is required for the uptower wind turbine repairs.

13. The wind turbine of claim 12, wherein the hoistable platform assembly further comprises a frame structure arranged above the plurality of tooling containers and secured to the working surface via one or more connecting members, the frame structure comprising a first set of lifting devices and a second set of lifting devices.

14. The wind turbine of claim 13, wherein the working surface comprises a corresponding set of lifting devices that align with the first set of lifting devices of the frame structure, the one or more connecting members being secured to each of the lifting devices.

15. The wind turbine of claim 13, wherein the frame structure further comprises parallel columns having a plurality of beams mounted perpendicularly thereto and an even number of the second set of lifting devices, wherein the same number of lifting devices is mounted to each of the parallel columns.

16. The wind turbine of claim 13, further comprising a hoisting cable configured with each of the first set of lifting devices, the hoistable cables joined together at a node, the node comprising an attachment location for a crane capable of lifting the platform assembly uptower.

17. The wind turbine of claim 12, wherein the platform frame is configured to sit within an opening within the nacelle where one or more drivetrain components has been removed.

18. A method for preparing a wind turbine for an uptower repair procedure, the method comprising:
removing at least one drivetrain component supported by a bedplate of the wind turbine from within of a nacelle of the wind turbine;
lifting a platform assembly uptower, the platform assembly having a working surface, a platform frame, and a plurality of tooling containers secured to the working surface, each of the tooling containers having at least one tool secured therein that is required for the uptower repair procedure; and,
installing the platform frame of the platform assembly within the nacelle at a location of the removed drivetrain component.

19. The method of claim 18, wherein installing the platform frame of the platform assembly within the nacelle at the location of the removed drivetrain component further comprises fitting the platform frame into the location via one or more locking features thereof.

20. The method of claim 18, wherein removing at least one drivetrain component supported by the bedplate of the wind turbine from within of the nacelle of the wind turbine reveals an opening in a base wall of the nacelle, the method further comprising covering the opening in the base wall of the nacelle with the platform assembly.
